(19) United States
(12) Patent Application Publication
(10) Pub. No.: US 2009/0273577 A1
(43) Pub. Date: Nov. 5, 2009

(54) Moire-Free Touch Screen with Tilted or Curved ITO Pattern

(75) Inventors: Cheng Chen, Cupertino, CA (US); Jun Qi, Cupertino, CA (US); John Z. Zhong, Cupertino, CA (US)

Correspondence Address: APPLE C/O MORRISON AND FOERSTER ,LLP;LOS ANGELES, 555 WEST FIFTH STREET SUITE 3500, LOS ANGELES, CA, 90013-1024, US

(73) Assignee: Apple Inc., Cupertino, CA (US)

(21) Appl. No.: 12/112,950

(22) Filed: Apr. 30, 2008

(51) Int. Cl. G06F 3/045; H04M 1/00; G06F 17/00

(52) U.S. Cl. 345/174; 455/566; 700/94

(57) ABSTRACT

Touch screens that generate reduced Moiré effects are disclosed. To reduce Moiré effects, the columns (drive or sense lines) of a touch sensor panel can be oriented at an angle with respect to a display device so that the columns are not parallel with the sub-pixel and pixel arrangements of the display device. In some embodiments, the entire touch sensor panel can be oriented at an angle with respect to the display device. In other embodiments, certain lines in the touch sensor panel can be tilted, curved or formed in a zig-zag shape.

### FIELD OF THE INVENTION

This relates generally to touch screens formed from touch sensor panels and display devices, and more particularly, to touch screens with reduced Moiré effects.

### BACKGROUND OF THE INVENTION

Many types of input devices are presently available for performing operations in a computing system, such as buttons or keys, mice, trackballs, joysticks, touch sensor panels, touch screens and the like. Touch screens, in particular, are becoming increasingly popular because of their ease and versatility of operation as well as their declining price. Touch screens can include a touch sensor panel, which can be a clear panel with a touch-sensitive surface, and a display device such as a liquid crystal display (LCD) that can be positioned partially or fully behind the panel so that the touch-sensitive surface can substantially cover the viewable area of the display device. Touch screens can allow a user to perform various functions by touching the touch sensor panel using a finger, stylus or other object at a location dictated by a user interface (UI) being displayed by the display device. In general, touch screens can recognize a touch event and the position of the touch event on the touch sensor panel, and the computing system can then interpret the touch event in accordance with the display appearing at the time of the touch event, and thereafter can perform one or more actions based on the touch event.

Mutual capacitance touch sensor panels can be formed from a matrix of drive and sense lines of a substantially transparent conductive material such as Indium Tin Oxide (ITO), often arranged in rows and columns in horizontal and vertical directions. Sensors or pixels can be formed where the drive and sense lines cross over each other while being separated by a dielectric material to form a capacitive sensing node. In order to scan a touch sensor panel and compute an image of touch, one or more frequencies can be used to stimulate the drive lines of the touch sensor panel, and charge or sense amplifiers coupled to the sense lines can be configured to detect any changes in the amount of charge coupled across the pixels. The changes in charge coupling can be converted to digital values and used in calculations to determine an image of touch for the touch sensor panel.

Behind the touch panel, the display device can have red, green and blue sub-pixels (forming individual pixels) and black mask patterned in horizontal and vertical directions, parallel to the drive and sense lines of the touch sensor panel. The pattern formed by the drive and sense lines can have a periodicity different from that of the display sub-pixels and black mask. Because the drive and sense lines may not be entirely clear (that is, the drive and sense lines can have a transmittance value lower than the neighboring areas) the superposition of the touch sensor panel and the display device can cause aliasing effects. As a result, visually unappealing Moiré patterns can appear as alternating brighter and darker regions or bands. In general, Moiré effects can be produced by two overlapping entities with regular patterns, and can appear as a regular pattern of lines that can be more pronounced if the periodicity of the pattern of one entity is an integer multiple of the periodicity of the pattern of the second entity.

FIG. 1 illustrates exemplary Moiré pattern 100 that can appear when two sets of lines with slightly different pitches (periodicity) are superimposed.

As the resolution of touch screens continues to increase to satisfy the demand of more sophisticated UIs, drive and sense line patterns become finer, closer to the pitch of display pixels. In addition, larger touch screens and finer patterns can require thicker drive and sense lines to maintain the line resistance within a drivable region, leading to a higher contrast between the drive and sense lines and surrounding areas (the clear substrate) on the touch panel. These factors can make touch screens more susceptible to Moiré effects.

### SUMMARY OF THE INVENTION

This relates to touch screens that generate reduced Moiré effects. To reduce Moiré effects, the columns (drive or sense lines) of a touch sensor panel can be oriented at an angle with respect to a display device so that the columns are not parallel with the sub-pixel and pixel arrangements of the display device. In some embodiments, the entire touch sensor panel can be oriented at an angle with respect to the display device. In other embodiments, certain lines in the touch sensor panel can be tilted, curved or formed in a zig-zag shape.

The purpose of angling the columns with respect to the pixel array is to break down the regular interference patterns that can otherwise occur. Note that the angle need not be 45 degrees—a small shift (e.g. 10 degrees) can be sufficient to reduce Moiré effects, although in embodiments of the invention the angle can be any angle greater than zero degrees but less than 90 degrees.

Note that in some embodiments, the rows (drive or sense lines) need not be angled because Moiré effects can be much less pronounced in the horizontal direction. The sub-pixels in the horizontal direction can form alternating R, G and B patterns, so that in any one row all three colors are present, which results in minimal or no Moiré effects. By comparison, when the same color sub-pixels of the display device are vertically aligned, any particular column contains sub-pixels of the same color, and therefore Moiré effects can be much more pronounced in the vertical direction.

### BRIEF DESCRIPTION OF THE DRAWINGS

FIG. 1 illustrates an exemplary Moiré pattern that can appear when two sets of lines with slightly different pitches (periodicity) are superimposed.

FIG. 2 illustrates an exemplary touch sensor panel having drive and sense lines patterned to benefit from embodiments of the invention.

FIG. 3 illustrates an exemplary display device having sub-pixels oriented to benefit from embodiments of the invention.

FIG. 4 illustrates a portion of an exemplary touch sensor panel superimposed over a portion of an exemplary display device in a conventional touch screen.

FIG. 5 illustrates an exemplary touch screen including a touch sensor panel and a display device arranged to reduce Moiré effects according to embodiments of the invention.

FIG. 6a illustrates an exemplary touch screen including a display device and a touch sensor panel having sense lines formed to reduce Moiré effects according to embodiments of the invention.

FIG. 6b illustrates another exemplary touch screen including a display device and a touch sensor panel having sense lines formed to reduce Moiré effects according to embodiments of the invention.

FIG. 7 illustrates an exemplary touch screen including a touch sensor panel and a display device having diagonal subpixels and pixels arranged to reduce Moiré effects according to embodiments of the invention.

FIG. 8 illustrates an exemplary computing system that can include a touch sensor panel and a display device arranged to reduce Moiré effects according to embodiments of the invention.

FIG. 9a illustrates an exemplary mobile telephone that can include a touch sensor panel and a display device arranged to minimize Moiré effects according to embodiments of the invention.

FIG. 9b illustrates an exemplary digital media player that can include a touch sensor panel and a display device arranged to minimize Moiré effects according to embodiments of the invention.

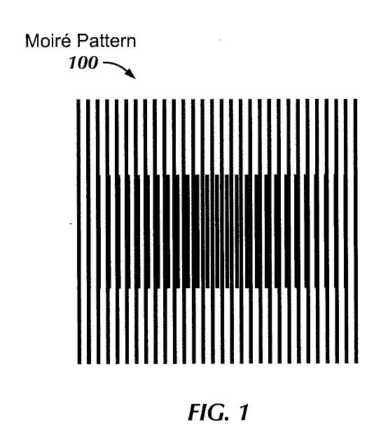

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

This relates to touch screens that generate reduced Moiré effects. To reduce Moiré effects, the drive and/or sense lines of a touch sensor panel can be oriented at an angle with respect to a display device so that the drive and sense lines are not parallel with the sub-pixel and pixel arrangements of the display device. In some embodiments, the entire touch sensor panel can be oriented at an angle with respect to the display device. In other embodiments, certain lines in the touch sensor panel can be tilted, curved or formed in a zig-zag shape.

Although embodiments of the invention may be described and illustrated herein primarily in terms of mutual capacitance touch sensor panels (described above), it should be understood that embodiments of the invention are also applicable to self-capacitance touch sensor panels. Self-capacitance touch sensor panels contain sensors whose capacitance to ground can vary in accordance with the amount of touch, and can also be arranged vertically and horizontally. Furthermore, embodiments of the invention are applicable to both multi- and single-touch sensor panels.

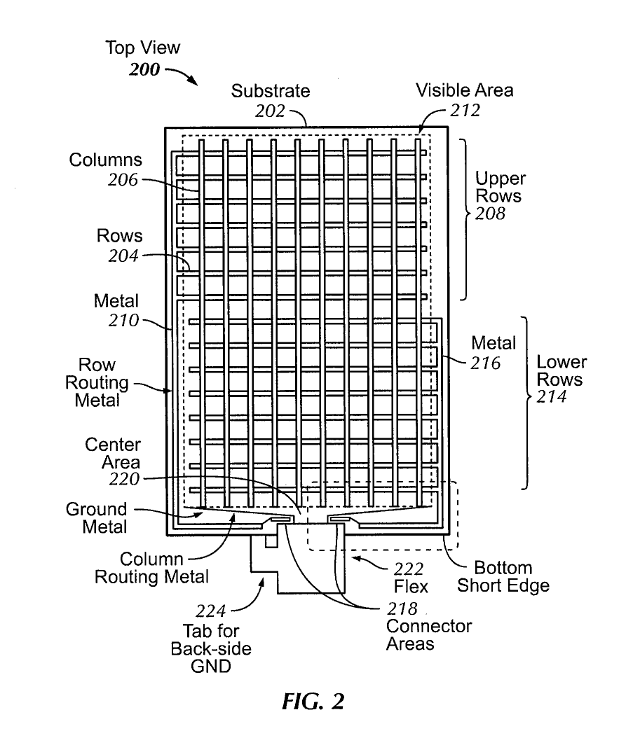

FIG. 2 illustrates an exemplary touch sensor panel having substantially transparent drive and sense lines patterned on a substantially transparent substrate to benefit from embodiments of the invention. The example of FIG. 2 shows top view 200 of exemplary substrate 202 with drive rows 204 and sense columns 206 formed on the top side and connected at a single end. Upper rows 208 can be connected to the bottom short edge of substrate 202 using metal traces 210 running along the left border of the substrate, outside visible area 212. Lower rows 214 can be connected to the bottom short edge of substrate 202 using metal traces 216 running along the right border of the substrate, outside visible area 212. By connecting the rows to metal traces at only one end, the metal traces can take up less width in the border areas and can be made wider, lowering their resistivity. The metal traces connecting the rows can be connected to bond pads in small connector areas 218 near the middle of the bottom short edge of substrate 202. The column traces can be routed to center 220 of the small connector area using metal traces. Note that flex circuit 222 in FIG. 2 can be made very small, and includes tab 224 for connecting to a shield layer on the back side of the substrate.

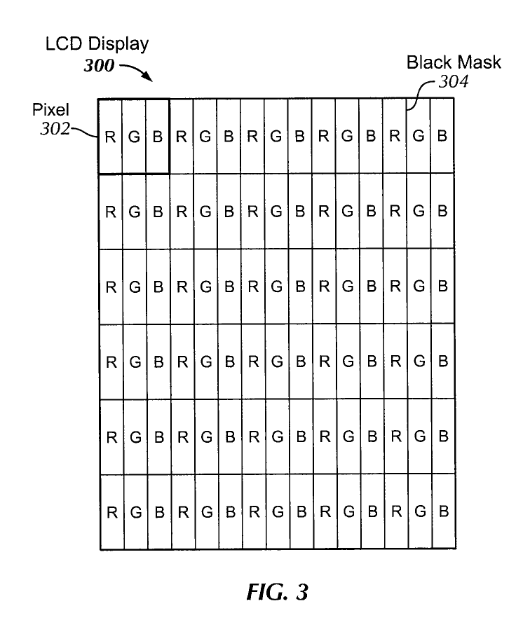

FIG. 3 illustrates an exemplary display device having sub-pixels oriented to benefit from embodiments of the invention. In the example of FIG. 3, exemplary display device 300 includes a repeating array of red (R), green (G) and blue (B) sub-pixels, each group of R, G and B sub-pixels forming pixel 302. Note that the subpixels are arranged so that the R subpixels are linearly aligned with each other in a vertical orientation, as are the G and B subpixels. The lines separating the sub-pixels can be filled with black mask 304 to reduce light leakage from the backlight of the display device.

Exemplary touch sensor panel 200 of FIG. 2 and exemplary display device 300 of FIG. 3 can benefit from embodiments of the invention primarily because sense columns 206 of the touch sensor panel are oriented vertically, in the same orientation as the columns of same-color sub-pixels of the display device.

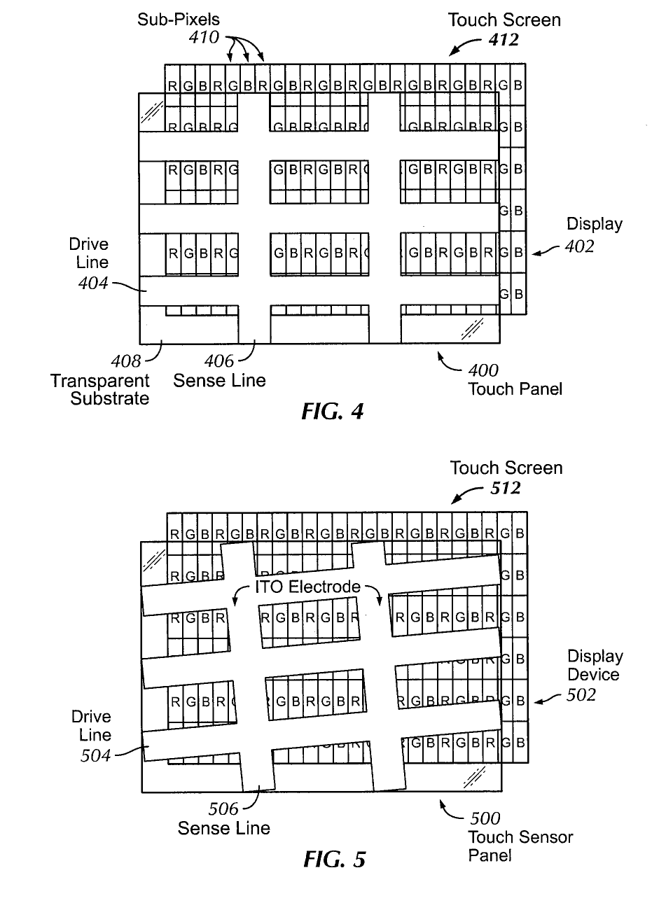

FIG. 4 illustrates a portion of exemplary touch sensor panel 400 superimposed over a portion of exemplary display device 402 in a conventional touch screen 412. Touch sensor panel 400 can include drive lines 404 and sense lines 406 arranged in rows and columns. Drive and sense lines 404 and 406 can be formed from a substantially transparent conductive material such as ITO on substantially transparent substrate 408. However, if drive and sense lines 404 and 406 have transmittance values different from substrate 408, the drive and sense lines can be seen on the substrate. Because both the display device sub-pixels 410 and the touch sensor drive and sense lines 404 and 406 can be oriented along parallel axes, Moiré effects can appear.

FIG. 5 illustrates exemplary touch screen 512 including touch sensor panel 500 and display device 502 according to embodiments of the invention. In the example of FIG. 5, the entire touch sensor panel 500 is angled (i.e. non-parallel) with respect to the pixel array of display device 502, resulting in drive lines 504 and sense lines 506 being angled with respect to the pixel array of display device 502. The purpose of angling drive and sense lines 504 and 506 with respect to the pixel array is to break down the regular interference patterns that can otherwise occur. Note that the angle need not be 45 degrees—a small shift (e.g. 10 degrees) can be sufficient to reduce Moiré effects, although in embodiments of the invention the angle can be any angle greater than zero degrees but less than 90 degrees. Although the example of FIG. 5 illustrates display device 502 oriented along the X-Y axes and touch sensor panel 500 being angled with respect to the X-Y axes, in other embodiments, the touch sensor panel can be oriented along the X-Y axes and the display device can be angled with respect to the X-Y axes. Furthermore, it should be understood that although the example of FIG. 5 shows sense lines 506 slightly angled with respect to the vertically aligned same-color subpixels of display device 502, in general either the drive or sense lines can be slightly angled with respect to the alignment of the same-color pixels of the display device.

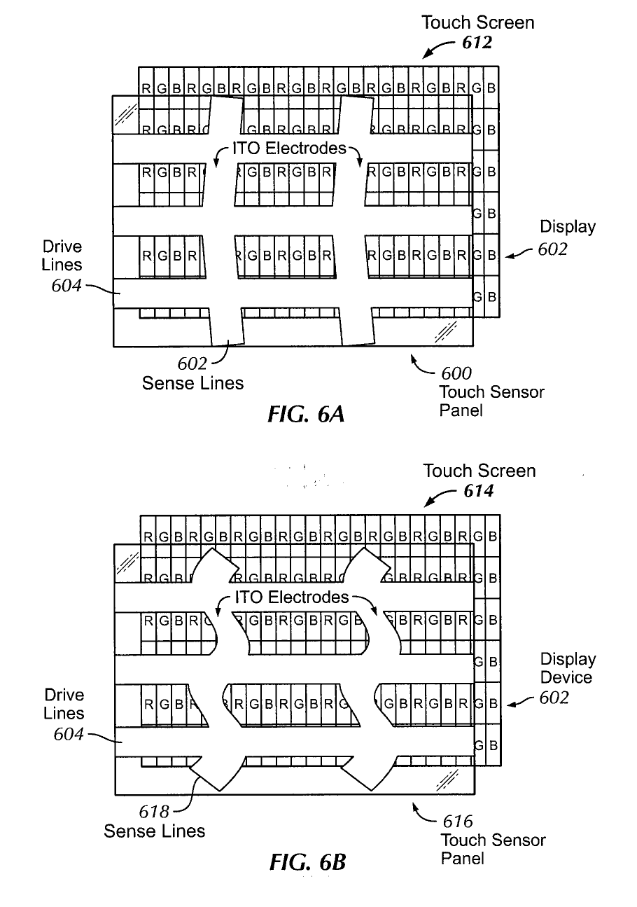

FIG. 6a illustrates exemplary touch screen 612 including touch sensor panel 600 and display device 602 according to embodiments of the invention. In the example of FIG. 6a, the axes of touch sensor panel 600 and display device 602 are aligned, but sense lines 606 are locally tilted or angled (i.e. non-parallel) with respect to the pixel array of display device 602. In other words, in the example of FIG. 6a, only sense lines 606 are tilted or angled with respect to the pixel array, with drive lines 604 and the touch sensor panel 600 remaining oriented along the X-Y axes.

Note that drive lines 604 in the example of FIG. 6a are not angled because Moiré effects can be much less pronounced in the horizontal direction when the same color sub-pixels of the LCD are vertically aligned. By comparison, the sub-pixels in the horizontal direction form alternating R, G and B patterns, so that in any one row all three colors are present, which results in minimal or no Moiré effects.

FIG. 6b illustrates another exemplary touch screen 614 including touch sensor panel 616 and display device 602 according to embodiments of the invention. In the example of FIG. 6b, the axes of touch sensor panel 616 and display device 602 are aligned, but sense lines 618 are locally curved (i.e. non-parallel) with respect to the pixel array of display device 602. In the embodiments of FIGS. 6a and 6b, the amount of deviation from a straight line (e.g. vertical) can be selected to reduce Moiré effects without greatly increasing the line resistance. In other words, the spatial repeating pattern of the sense line should be on a small scale, so that the current is not forced to take a meandering and therefore high resistance path.

It should be understood that although the examples of FIGS. 6a and 6b shows the sense lines 602 or 618 slightly angled or curved with respect to the vertically aligned same-color subpixels of display device 602, in general either the drive or sense lines can be slightly angled or curved with respect to the alignment of the same-color pixels of the display device.

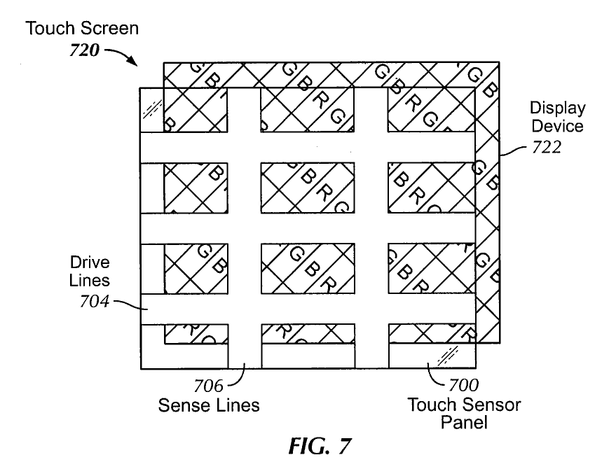

FIG. 7 illustrates another exemplary touch screen 720 including touch sensor panel 700 and display device 722 according to embodiments of the invention. In the example of FIG. 7, display device 722 includes a diagonal subpixel array, while drive lines 704 and sense lines 706 of touch sensor panel 700 are oriented along the X and Y axes. With these orientations, Moiré effects can be greatly reduced.

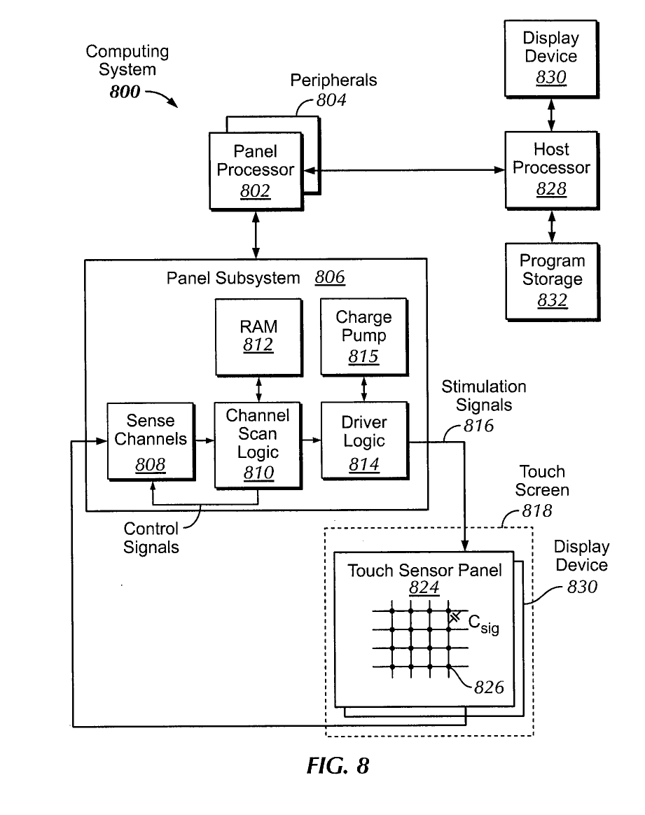

FIG. 8 illustrates exemplary computing system 800 that can include one or more of the embodiments of the invention described above. Computing system 800 can include one or more panel processors 802 and peripherals 804, and panel subsystem 806. Peripherals 804 can include, but are not limited to, random access memory (RAM) or other types of memory or storage, watchdog timers and the like. Panel subsystem 806 can include, but is not limited to, one or more sense channels 808, channel scan logic 810 and driver logic 814. Channel scan logic 810 can access RAM 812, autonomously read data from the sense channels and provide control for the sense channels. In addition, channel scan logic 810 can control driver logic 814 to generate stimulation signals 816 at various frequencies and phases that can be selectively applied to drive lines of touch sensor panel 824. In some embodiments, panel subsystem 806, panel processor 802 and peripherals 804 can be integrated into a single application specific integrated circuit (ASIC).

Touch sensor panel 824 can include a capacitive sensing medium having a plurality of drive lines and a plurality of sense lines, although other sensing media can also be used. Each intersection of drive and sense lines can represent a capacitive sensing node and can be viewed as picture element (pixel) 826, which can be particularly useful when touch sensor panel 824 is viewed as capturing an “image” of touch. (In other words, after panel subsystem 806 has determined whether a touch event has been detected at each touch sensor in the touch sensor panel, the pattern of touch sensors in the multi-touch panel at which a touch event occurred can be viewed as an “image” of touch (e.g. a pattern of fingers touching the panel).) Each sense line of touch sensor panel 824 can drive sense channel 808 (also referred to herein as an event detection and demodulation circuit) in panel subsystem 806.

Computing system 800 can also include host processor 828 for receiving outputs from panel processor 802 and performing actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 828 can also perform additional functions that may not be related to panel processing, and can be coupled to program storage 832 and display device 830 such as an LCD display for providing a UI to a user of the device. Display device 830 together with touch sensor panel 824, when located partially or entirely under the touch sensor panel, can form touch screen 818.

Note that one or more of the functions described above can be performed by firmware stored in memory (e.g. one of the peripherals 804 in FIG. 8) and executed by panel processor 802, or stored in program storage 832 and executed by host processor 828. The firmware can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

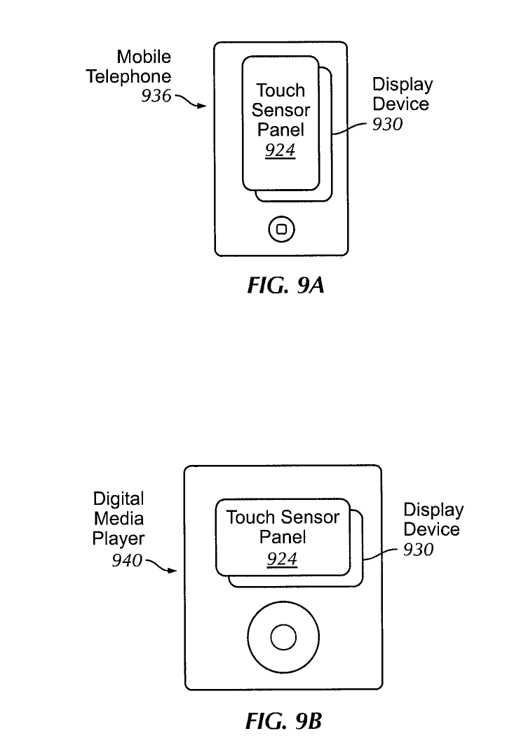

FIG. 9a illustrates exemplary mobile telephone 936 that can include touch sensor panel 924 and display device 930 arranged to minimize Moiré effects according to embodiments of the invention.

FIG. 9b illustrates exemplary digital media player 940 that can include touch sensor panel 924 and display device 930 arranged to minimize Moiré effects according to embodiments of the invention.

The mobile telephone and media player of FIGS. 9a and 9b can benefit from embodiments of the invention by providing a touch screen with reduced Moiré effects and an improved visual presentation.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A touch screen having reduced Moiré effects, comprising:
a display device, the display device having an array of subpixels of different colors, the subpixels of each color linearly aligned in a first orientation; and
a touch sensor panel at least partially superimposed over the display device, the touch sensor panel having a plurality of substantially transparent first lines and a plurality of substantially transparent second lines forming a capacitive sensor array on a substantially transparent substrate;
wherein the plurality of first lines are non-parallel with respect to the first orientation.

2. The touch screen of claim 1, wherein the plurality of first lines are oriented at an angle between zero and 90 degrees with respect to the first orientation.

3. The touch screen of claim 1, wherein the touch sensor panel is oriented at an angle between zero and 90 degrees with respect to the first orientation.

4. The touch screen of claim 1, wherein the plurality of first lines are locally oriented at an angle between zero and 90 degrees with respect to the first orientation.

5. The touch screen of claim 1, wherein the plurality of first lines are locally curved with respect to the first orientation.

6. The touch screen of claim 1, wherein the array of subpixels are oriented diagonally and the plurality of first and second lines are oriented horizontally and vertically.

7. The touch screen of claim 1, wherein the touch screen is incorporated within a computing system.

8. The touch screen of claim 1, wherein the computing system is incorporated into a mobile telephone.

9. The touch screen of claim 1, wherein the computing system is incorporated into a digital media player.

10. A method for reducing Moiré effects in a touch screen, comprising:
orienting a plurality of substantially transparent first lines in a touch sensor panel in relation to a display device such that the plurality of substantially transparent first lines are non-parallel with respect to a plurality of aligned subpixels of a like color in the display device.

11. The method of claim 10, further comprising orienting the plurality of first lines at an angle between zero and 90 degrees with respect to the plurality of aligned subpixels.

12. The method of claim 10, further comprising orienting the touch sensor panel at an angle between zero and 90 degrees with respect to the plurality of aligned subpixels.

13. The method of claim 10, further comprising locally orienting the plurality of first lines at an angle between zero and 90 degrees with respect to the plurality of aligned subpixels.

14. The method of claim 10, further comprising locally curving the plurality of first lines with respect to the plurality of aligned subpixels.

15. The method of claim 10, further comprising orienting the array of subpixels diagonally and orienting the plurality of first lines vertically.

16. A mobile telephone including a touch screen having reduced Moiré effects, the touch screen comprising:
a display device, the display device having an array of subpixels of different colors, the subpixels of each color linearly aligned in a first orientation; and
a touch sensor panel at least partially superimposed over the display device, the touch sensor panel having a plurality of substantially transparent first lines and a plurality of substantially transparent second lines forming a capacitive sensor array on a substantially transparent substrate;
wherein the plurality of first lines are non-parallel with respect to the first orientation.

17. A digital media player including a touch screen having reduced Moiré effects, the touch sensor panel comprising:
a display device, the display device having an array of subpixels of different colors, the subpixels of each color linearly aligned in a first orientation; and
a touch sensor panel at least partially superimposed over the display device, the touch sensor panel having a plurality of substantially transparent first lines and a plurality of substantially transparent second lines forming a capacitive sensor array on a substantially transparent substrate;
wherein the plurality of first lines are non-parallel with respect to the first orientation.
